(19) United States
(12) Patent Application Publication
(10) Pub. No.: US 2026/0237388 A1
(43) Pub. Date: Aug. 13, 2026

(54) METHOD FOR ASSISTING A DRIVER TO DRIVE A VEHICLE, RELATED COMPUTER PROGRAM AND ELECTRONIC DEVICE

(71) Applicant: Faurecia Clarion Electronics Europe, Paris (FR)

(72) Inventors: Farah ABDEL KHALEK, PARIS (FR); Giovanni MION, Saint-Maur-des-Fossés (FR); Samer AMMOUN, MAISONS ALFORT (FR); Julien MARTINIAK, Bernay-Vilbert (FR)

(21) Appl. No.: 19/537,064

(22) Filed: Feb. 11, 2026

(30) Foreign Application Priority Data
Feb. 11, 2025 (FR) FR 25 01409

(51) Int. Cl. G10L 15/22

(52) U.S. Cl. CPC G10L 15/22; G10L 2015/223

(57) ABSTRACT

A system and method for assisting a driver with driving a vehicle, the method being implemented by an electronic device suitable for connection to an electronic conversation module having a voice assistance algorithm. The method implemented by the system includes: creating a user profile for the driver, determining a physical state of the driver via at least one image of the driver, the physical state being determined via an image processing algorithm, and when the determined state of the driver is among a predefined list of states, controlling the electronic conversation module to implement a voice conversation with the driver. The controlling of the voice conversation being implemented based on the user profile and the physical state of the driver, which are received as input to the voice assistance algorithm.

### CROSS-REFERENCE TO RELATED APPLICATIONS

This application is a U.S. non-provisional application claiming the benefit of French Application No. 25 01409, filed on Feb. 11, 2025, which is incorporated herein by reference in its entirety.

### TECHNICAL FIELD

The present invention relates to a method for assisting a driver with driving a vehicle.

The invention also relates to a computer program comprising software instructions which, when executed by a computer, implement such a driving assistance method.

The invention also relates to an electronic device for assisting with driving a vehicle.

The invention then relates to the field of on-board electronic systems for vehicles, and more specifically electronic devices and associated methods for assisting with driving vehicles.

### BACKGROUND

In a manner known per se, a vehicle is equipped with a plurality of on-board systems, enabling different functions of the vehicle to be implemented.

In particular, certain on-board systems present in the majority of present-day road vehicles are dedicated to assisting the driver with driving the vehicle. Mention may be made, for example, of emergency brake assist (EBA) and power steering.

In addition, there are on-board devices to monitor the physical and emotional state of the driver. These devices are called DMS (Driver Monitoring System), and were initially developed and introduced in modern vehicles to address the problems of drowsiness and inattention at the wheel.

Current technological solutions, such as DMSs equipped with image sensors, make it possible to take into account other indicators of the driver's attention, linked especially to emotions felt by the driver, such as, for example, irritation or stress, which can be the cause of aggressive maneuvers at the wheel, such as speeding or failure to observe safety distances. After detecting a negative emotion, these DMSs can be configured to emit warning sounds or display warning messages on the dashboard, to help the driver refocus on their driving.

Such solutions also include voice assistance devices, configured to answer questions asked by the driver at the wheel. These voice assistance devices are generally based on LLMs (Large Language Models), and, like the GPT (Generative Pre-trained Transformer) modules developed by OpenAI™, are connected to on-board DMSs via an Internet network.

However, current DMSs and, in particular, the voice assistance devices included in these DMSs are simply adapted to respond to instructions issued by the driver.

Moreover, the warning sounds emitted in response to the detection of a negative emotion can often be disturbing for the driver, and the warning messages displayed sometimes prove ineffective.

### SUMMARY

There is a need to propose a solution that makes it possible to monitor the physical and psychological state of the driver at the wheel, and interact with them in a personalized way if their state is unsuitable for safe driving, with a view to remedying it more effectively.

An aim of the invention is therefore to propose a method for assisting a driver with driving a vehicle, making it possible to detect a driver's physical state that is unsuitable for safe driving, and to generate a suitable voice conversation with them.

To this end, there is disclosed herein a method for assisting a driver with driving a vehicle, the method being implemented by an electronic driving assistance device suitable for connection to an electronic conversation module, the vehicle comprising at least one loudspeaker, a microphone and an image sensor, said method comprising the following steps:
creating a user profile for the driver, the user profile comprising at least one user datum selected from the group comprising: the name of the driver, the occupation of the driver and a set of interest(s) of the driver,
determining a physical state of the driver via at least one image received from the image sensor, said physical state being determined via the implementation of an image processing algorithm, and
if said determined state of the driver is among a predefined list of states, controlling the electronic conversation module to implement a voice conversation with the driver via the at least one loudspeaker and the microphone, said electronic conversation module comprising a voice assistance algorithm, the controlling of the voice conversation being implemented based on the user profile and the physical state of the driver, which are received as input to the voice assistance algorithm.

With the driving assistance method according to the invention, and by virtue especially of the use of user data and of the detected physical state as input to the voice assistance algorithm, the voice conversation module generates a personalized and natural conversation with the driver, which increases the chances of remedying their detected physical state, leading to the implementation of safer driving for themselves and for other road users.

According to other advantageous aspects of the invention, the driving assistance method comprises one or more of the following features, taken alone or in any technically feasible combination:
the predefined list of states comprises the following states: drowsy, happy, excited, sad and irritated;
the physical state determined is among a normal state and the predefined list of states, the controlling of the voice conversation with the driver being implemented if the physical state determined is different from the normal state;
the determination step is repeated after a predetermined time interval and the physical state of the driver is updated by the image processing algorithm;
the control step further comprises increasing the volume of the at least one loudspeaker, if the physical state of the driver determined in the previous determination step is equal to drowsy, and if the physical state of the driver determined in the current determination step is still equal to drowsy;
a step of updating the user profile after each controlling of a voice conversation, said updating comprising at least one action selected from the group comprising: adding at least one user datum, deleting at least one user datum and modifying at least one user datum;
the image processing algorithm is a pre-trained artificial intelligence image recognition algorithm;
the voice assistance algorithm is a pre-trained artificial intelligence voice assistance algorithm;
the voice assistance algorithm being preferably based on a large language model (LLM).

The invention also relates to a non-transitory computer-readable storage medium having stored therein a computer program comprising software instructions which, when executed by a computer, implement such a driving assistance method as defined above.

The invention also relates to an electronic device for assisting a driver with driving a vehicle, said electronic device being suitable for connection to an electronic conversation module, the vehicle comprising at least one loudspeaker, a microphone and an image sensor, said electronic device comprising:
a creation module configured to create a user profile for the driver, the user profile comprising at least one user datum selected from the group comprising: the name of the driver, the occupation of the driver and a set of interest(s) of the driver,
a determination module configured to determine a physical state of the driver via at least one image received from the image sensor, said state being determined via the implementation of an image processing algorithm, and
a control module configured, if said determined state of the driver is among a predefined list of states, to control the electronic conversation module to implement a voice conversation with the driver via the at least one loudspeaker and the microphone, said electronic conversation module comprising a voice assistance algorithm,
the control module being further configured to control the voice conversation based on the user profile and the physical state of the driver, which are received as input to the voice assistance algorithm.

According to other advantageous aspects of the invention, the electronic driving assistance device comprises one or more of the following features, taken alone or in any technically feasible combination:

the creation module is further configured to create the user profile for the driver by asking the driver at least one question via the at least one loudspeaker, and by receiving via the microphone an answer for each of the at least one question.

The invention also relates to a motor vehicle comprising an electronic device for assisting a driver with driving the vehicle, the device being as defined above.

### BRIEF DESCRIPTION OF THE DRAWINGS

The invention will become clearer on reading the following description, given solely by way of non-limiting example, and made with reference to the drawings, wherein:

FIG. 1 is a schematic perspective view of the inside of the passenger compartment of a vehicle comprising an electronic driving assistance device according to an embodiment of the invention; and

FIG. 2 is a flowchart of a driving assistance method according to an embodiment of the invention.

### DETAILED DESCRIPTION

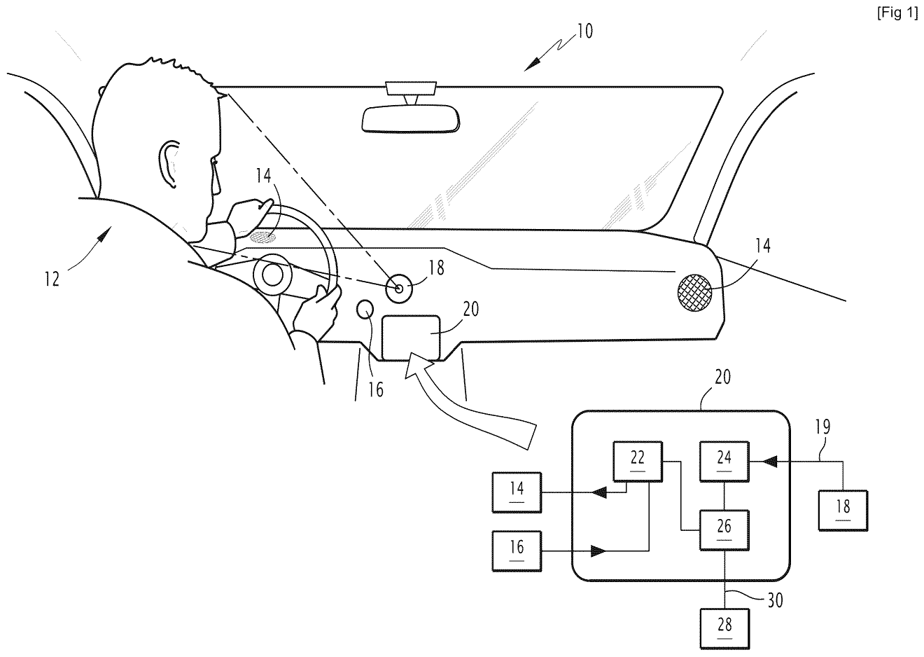

FIG. 1 shows the inside of the passenger compartment of a vehicle 10 driven by a driver 12.

The vehicle 10 is preferably a motor vehicle, such as a car, truck or bus.

Alternatively, the vehicle 10 is selected from the group comprising: a rail vehicle, such as a train or streetcar; a naval vehicle, such as a ship; and an aeronautical vehicle, such as an aircraft.

The vehicle 10 comprises a pair of loudspeakers 14, a microphone 16, and an image sensor 18, each arranged inside the passenger compartment.

The vehicle 10 further comprises an electronic device 20 for assisting the driver 12 with driving the vehicle 10, the electronic device 20 being designed to be on board the vehicle 10.

Each loudspeaker 14 is configured to emit a plurality of sound signals inside the passenger compartment, in particular to the driver 12, especially one or more sound instructions, such as voice messages.

The microphone 16 is designed to receive a plurality of sound signals from inside the passenger compartment, in particular from the driver 12, especially one or more sound instructions, such as voice messages.

The image sensor 18 is configured to acquire at least one image 19 of the driver 12, especially of their face. The image sensor 18 is typically selected from the group comprising: an infrared sensor, a visible spectrum image sensor, a 3D image sensor and a structured light sensor. The infrared sensor is also called an IR sensor, and is configured to take at least one infrared image 19 of the driver 12, in particular an infrared image 19 of their face. The visible spectrum image sensor is configured to take at least one image 19 of the driver 12 in the visible spectrum, in particular an image 19 of their face in the visible spectrum. Visible spectrum image sensors are also known as RGB (Red Green Blue) sensors. The structured light sensor is, for example, a three-dimensional (3D) sensor.

The image sensor 18 is preferably positioned opposite the driver 12, that is, facing the driver 12, as shown in FIG. 1.

Alternatively, the image sensor 18 is positioned on the dashboard of the vehicle 10, and oriented toward the driver 12 so as to be able to take at least one image 19 of the driver 12, in particular an image 19 of their face.

The electronic device 20, shown in FIG. 1, is configured to assist the driver 12 of the vehicle 10 by controlling a voice conversation with the driver 12.

The electronic device 20 then comprises a creation module 22, a determination module 24 and a control module 26, the electronic device 20 being suitable for connection to an electronic conversation module 28 via a connection 30.

The creation module 22 is connected to the loudspeakers 14 and to the microphone 16. The determination module 24 is connected to the image sensor 18. The control module 26 is connected to the creation module 22, to the determination module 24 and to the electronic conversation module 28.

In the example shown in FIG. 1, the electronic device 20 comprises an information processing unit (not shown) that is formed, for example, by a memory and a processor associated with the memory. The electronic device 20 also comprises a storage memory (not shown).

In the example shown in FIG. 1, the creation module 22, the determination module 24 and the control module 26 are each produced in the form of software, or a software component, executable by the processor. The memory is then able to store creation software, determination software and control software. The processor is then able to execute each of these pieces of software among the creation software, the determination software and the control software.

In a variant which is not shown, the creation module 22, the determination module 24 and the control module 26 are each produced in the form of a programmable logic component, such as an FPGA (Field Programmable Gate Array), or in the form of a dedicated integrated circuit, such as an ASIC (Application Specific Integrated Circuit).

When the electronic device 20 is produced in the form of one or more pieces of software, that is, in the form of a computer program, it is further able to be recorded on a computer-readable medium (not shown). The computer-readable medium is, for example, a medium able to store electronic instructions and to be coupled to a bus of a computer system. By way of example, the readable medium is an optical disk, a magneto-optical disk, a ROM memory, a RAM memory, any type of non-volatile memory (for example FLASH or NVRAM), or a magnetic card. A computer program containing software instructions is then stored on the readable medium.

The creation module 22 is configured to create a user profile for the driver 12, the user profile comprising at least one user datum selected from the group comprising: the name of the driver 12, the occupation of the driver 12 and a set of interest(s) of the driver 12.

Advantageously, the creation module 22 is configured to create the user profile for the driver 12 by asking the driver at least one question via the loudspeakers 14, and by receiving via the microphone 16 an answer from the driver 12 for each of the at least one question.

For example, during the first use of the electronic device 20 by the driver 12, the creation module 22 operates the loudspeakers 14 so that they emit at least one sound signal comprising the question “What's your name?” to the driver 12. The microphone 16 then receives at least one sound signal from the driver 12 comprising the answer to the question, and transmits said at least one signal to the creation module 22. The creation module 22 is then configured to create a user profile comprising the name of the driver 12 obtained in response to said question.

Advantageously, the creation module 22 is further designed to create a plurality of user profiles, each user profile being associated with a different driver 12 of the vehicle 10.

The determination module 24 is configured to determine a physical state of the driver 12 via at least one image 19 received from the image sensor 18.

The determination module 24 comprises an image processing algorithm, configured to implement the determination of said physical state of the driver 12.

Advantageously, the image processing algorithm is a pre-trained artificial intelligence image recognition algorithm.

Advantageously, the determination module 24 is configured to determine the physical state of the driver from a predetermined set of possible states, said predetermined set including a normal physical state, and a predefined list of states for which a voice conversation is preferentially initiated with the driver.

Said predefined list of states comprises, for example, the following states: drowsy and irritated. The predefined list of states preferably comprises the following states: drowsy, happy, excited, sad and irritated. The predefined list of states consists of, for example, the following states: drowsy, happy, excited, sad and irritated.

For example, if the at least one image 19 comprises a face of the driver 12 with open eyes looking toward the road, and relaxed eyebrows, the image processing algorithm determines a normal physical state of the driver 12.

According to another example, if the at least one image 19 comprises a face of the driver 12 with squinted eyes looking toward the road, the image processing algorithm determines a drowsy physical state of the driver 12, and the electronic device 20 is then able to initiate a voice conversation with the driver 12.

According to another example, if the at least one image 19 comprises a face of the driver 12 with downwardly frowning eyebrows and a slightly upturned nose, with a tight or pursed mouth, the image processing algorithm determines an irritated physical state of the driver 12, and a voice conversation with the driver 12 is thus initiated by the electronic device 20.

The control module 26 is configured to control the electronic conversation module 28 to implement a voice conversation between the driver 12 and the electronic conversation module 28 via the loudspeakers 14 and the microphone 16, if the physical state of the driver 12 determined by the determination module 24 is among the predefined list of states.

The control module 26 is further configured to control the electronic conversation module 28 based on the user profile created by the creation module 22 and the physical state of the driver 12 determined by the determination module 24.

In addition, the control module 26 is designed to transmit the user profile and the determined state of the driver 12 to the electronic conversation module 28.

For example, if the image processing algorithm determines a physical state of the driver 12 equal to irritated, the control module 26 is configured to transmit the physical state of the driver 12 and the user profile to the electronic conversation module 28. The electronic conversation module 28 receives this information, and generates, for example, a first question based on this information. This first question is advantageously linked to one of the user data included in the user profile. The control module 26 is then designed to receive this first question, and to transmit this first question to the loudspeakers 14 in order to start the implementation of the voice conversation with the driver 12. The microphone 16 then receives a plurality of sound signals comprising an answer from the driver 12 to this first question. The control module 26 is then configured to receive said answer from the microphone 16, and transmit said answer to the electronic conversation module 28.

Advantageously, the creation module 22 is further configured to update the user profile after each answer from the driver 12 during the voice conversation with the electronic conversation module 28.

A person skilled in the art will understand that “update the user profile” means add a user datum to the user profile and/or delete a user datum from the user profile and/or modify a user datum in the user profile.

The electronic conversation module 28 comprises a voice assistance algorithm, configured to implement said voice conversation with the driver 12.

As an optional extra, the voice assistance algorithm is a pre-trained artificial intelligence voice assistance algorithm.

As a further optional extra, the voice assistance algorithm is a pre-trained artificial intelligence voice assistance algorithm, based on an LLM.

The electronic conversation module 28 is connected to the control module 26 via the connection 30. Advantageously, the connection 30 is a connection to an Internet network.

The electronic conversation module 28 uses, for example, GPT (Generative Pre-trained Transformer), a module developed by OpenAI, to generate text responses. It also incorporates TTS (Text To Speech) to convert these responses into audible speech, and Whisper for speech transcription.

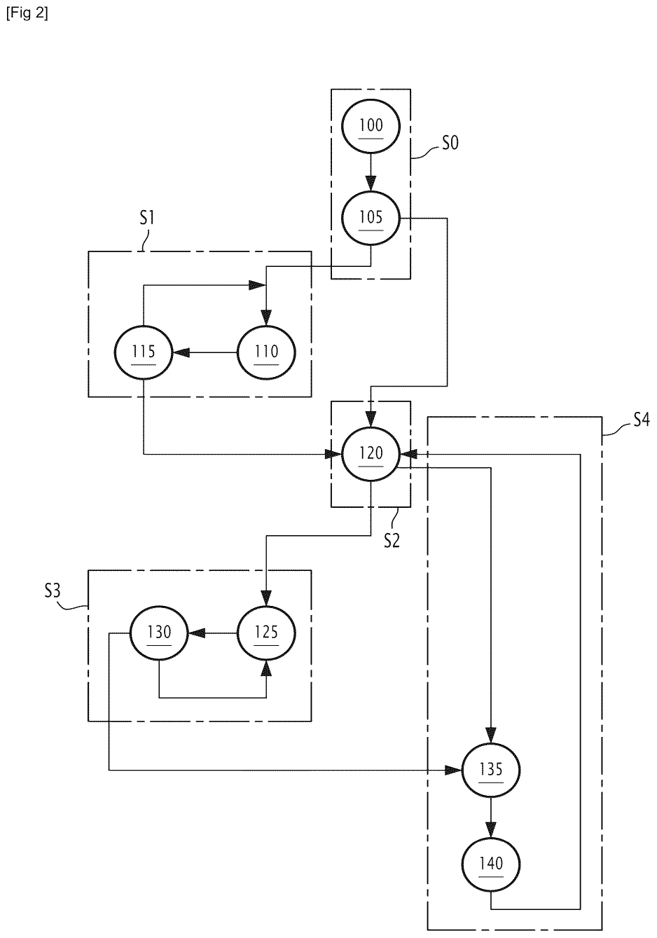

The operation of the electronic device 20 for assisting a driver 12 with driving a vehicle 10 will now be described, with reference to FIG. 2, which shows a flowchart of the driving assistance method.

The driving assistance method initially comprises a start-up step S0, comprising an initialization sub-step 100 and a recognition sub-step 105.

In the initialization sub-step 100, the electronic device 20 is initialized, and is configured especially to ensure that the various electrical connections with the loudspeakers 14, the microphone 16, the image sensor 18 and the electronic conversation module 28 are functional.

In the recognition sub-step 105, the electronic device 20 recognizes the driver 12 of the vehicle 10. The recognition sub-step 105 is implemented, for example, by operating the loudspeakers 14, for example by asking a question the answer to which makes it possible to identify the driver 12.

Alternatively, the recognition sub-step 105 is implemented through voice recognition by operating the microphone 16.

Alternatively again, the recognition sub-step 105 is implemented through facial recognition by operating the image sensor 18.

The method then comprises a creation step S1 comprising at least one questioning sub-step 110 and at least one reception sub-step 115; the creation module 22 creates a user profile for the driver 12.

A person skilled in the art will understand that the creation step S1 is implemented by the creation module 22, if the electronic device 20 has not recognized the driver 12 during the recognition sub-step 105. Consequently, if the electronic device 20 has recognized the driver 12 during the recognition sub-step 105, the creation module 22 is configured to retrieve, for example in a memory of the electronic device 20, the previously established user profile of the driver 12. In this case, as shown in FIG. 2, the creation step S1 is not implemented by the creation module 22.

During the at least one questioning sub-step 110, the creation module 22 asks the driver 12 a question, for example by operating the loudspeakers 14.

In another example, the creation module 22 asks the driver 12 a question via a message displayed on a dashboard of the vehicle 10.

Advantageously, the question asked enables the creation module 22 to collect a user datum from the driver 12, such as, for example, their name, their profession or one of their interests, during the reception sub-step 115 which follows one of the at least one questioning sub-step 110.

During the at least one reception sub-step 115, the creation module 22 receives an answer from the driver 12, for example via the microphone 16, to the question asked during the previous questioning sub-step 110.

In another example, the creation module 22 receives the answer to the question via a text input from the driver 12 on a dashboard of the vehicle 10.

The creation module 22 is then configured to create the user profile for the driver from the answers received during the at least one reception sub-step 115.

Furthermore, a person skilled in the art will understand that the at least one questioning sub-step 110 and the at least one reception sub-step 115 are part of an iterative process, ending when the creation module 22 has asked all the questions required to establish the user profile for the driver 12 during the at least one questioning sub-step 110.

For example, the creation module 22 is configured to ask the driver 12 five questions, and thus implements a first questioning sub-step 110, then a first reception sub-step 115, then a second questioning sub-step 110, and so on.

The method then comprises a determination step S2, also denoted determination sub-step 120 in FIG. 2, during which the determination module 24 determines a physical state of the driver 12 via at least one image 19 received from the image sensor 18.

Advantageously, the determination step S2 is repeated after a predetermined time interval, and the control module 26 is then configured to transmit the determined new physical state of the driver 12, so that the voice assistance algorithm receives the determined new physical state of the driver 12.

For example, during a first determination step S2, the determination module 24 receives an image 19 of the face of the driver 12, and determines a normal physical state of the driver 12. After a time interval of five seconds, the determination module 24 receives a second image 19 of the driver 12, and determines a drowsy physical state of the driver 12.

If the determination module 24 determines, during the determination step S2, a physical state of the driver 12 from the predefined list of states, the determination step S2 is followed by a control step S3, comprising a request sub-step 125 and a response sub-step 130.

During the request sub-step 125, the control module 26 is configured to transmit an instruction to the driver 12, by operating the loudspeakers 14.

Advantageously, this instruction is designed to enable the control module 26 to confirm or invalidate the physical state determined by the determination module 24 during the determination step S2.

For example, if during a determination step S2 the determination module 24 has determined a drowsy physical state of the driver 12, then the control module 26 is configured to implement the request sub-step 125, and, for example, to ask the driver 12 the question “Are you drowsy?” by operating the loudspeakers 14, in order to confirm or invalidate the physical state determined by the determination module 24.

Subsequently, during the response sub-step 130, the control module 26 receives a response to the instruction issued during the request sub-step 125, via the microphone 16.

In addition, if, after a predefined time delay has elapsed, the determined physical state of the driver 12 remains unchanged at drowsy, the control module 26 is configured to increase the volume of the loudspeakers 14.

The method further comprises an auxiliary conversation step S4, comprising a reception sub-step 135 and a conversation sub-step 140.

As shown in FIG. 2, the auxiliary conversation step S4 follows the determination step S2 or the control step S3.

The control module 26 is configured to implement the auxiliary conversation step S4 following the determination step S2 if, during the determination step S2, the control module 26 receives at least one sound signal from the driver 12, via the microphone 16.

For example, if during the determination step S2 the determination module 24 determines a normal physical state of the driver 12 and the control module 26 receives a question from the driver 12 via the microphone 16, then the control module 26 is configured to implement the auxiliary conversation step S4.

In addition, the control module 26 is configured to implement the auxiliary conversation step S4 following the control step S3.

During the reception sub-step 135, the control module 26 receives at least one sound signal from the driver 12, via the microphone 16, comprising an instruction from the driver 12. This at least one sound signal comprises, for example, a question from the driver 12, intended for the voice conversation module 28.

The control module 26 is then configured to transmit the received instruction to the voice conversation module 28 via the connection 30, so that the conversation module 28 generates a response to said instruction.

During the conversation sub-step 140, the control module 26 is configured to receive the response generated by the conversation module 28 during the reception sub-step 135, and to transmit said response to the driver 12 via the loudspeakers 14.

Furthermore, it should be noted that throughout the control step S3 and the auxiliary conversation step S4 of the method described above, the driver 12 is able to interrupt the voice conversation with the voice conversation module 28 by giving a voice or manual command, such as by pressing a mechanical button or a touch button displayed on a screen.

In other words, and with reference to FIG. 2, the determination module 24 periodically implements a determination step S2, thus periodically determining the physical state of the driver 12. If, during a determination step S2, a determined state of the driver 12 is unsuitable for driving the vehicle 10, the control module 26 implements a control step S3, followed by an auxiliary conversation step S4, thus controlling a voice conversation between the driver 12 and the electronic conversation module 28. As long as this is not the case, the control module 26 is configured to implement an auxiliary conversation step S4, if the control module 26 receives a sound signal from the driver 12 via the microphone 16.

Thus, the driving assistance method makes it possible to implement a voice conversation, centered around the user profile and the determined physical state, between the driver 12 and the conversation module 28.

Consequently, said voice conversation is personalized to the driver 12, and the electronic conversation module 28 generates responses by evoking topics related to the interests and the profile of the driver 12, thus helping the driver to alleviate potential negative emotions, and to be in a better position to drive the vehicle with improved safety.

1. A method for assisting a driver with driving a vehicle, the method being implemented by an electronic driving assistance device suitable for connection to an electronic conversation module, the vehicle comprising at least one loudspeaker, a microphone and an image sensor, said method comprising the following steps:
creating a user profile for the driver, the user profile comprising at least one user datum selected from the group comprising: the name of the driver, the occupation of the driver and a set of interest(s) of the driver,
determining a physical state of the driver via at least one image received from the image sensor, said physical state being determined via the implementation of an image processing algorithm, and
when said determined state of the driver is among a predefined list of states, controlling the electronic conversation module to implement a voice conversation with the driver via the at least one loudspeaker and the microphone, said electronic conversation module comprising a voice assistance algorithm,
wherein the controlling of the voice conversation is implemented based on the user profile and the physical state of the driver, which are received as input to the voice assistance algorithm.

2. The method according to claim 1, wherein the predefined list of states comprises the following states: drowsy, happy, excited, sad and irritated.

3. The method according to claim 1, wherein the physical state determined is among a normal state and the predefined list of states, the controlling of the voice conversation with the driver being implemented when the physical state determined is different from the normal state.

4. The method according to claim 1, wherein the determination step is repeated after a predetermined time interval and the physical state of the driver is updated by the image processing algorithm.

5. The method according to claim 4, wherein the control step further comprises increasing the volume of the at least one loudspeaker, when the physical state of the driver determined in the previous determination step is equal to drowsy, and when the physical state of the driver determined in the current determination step is still equal to drowsy.

6. The method according to claim 1, further comprising a step of updating the user profile after each controlling of a voice conversation, said updating comprising at least one action selected from the group comprising: adding at least one user datum, deleting at least one user datum and modifying at least one user datum.

7. The method according to claim 1, wherein the image processing algorithm is a pre-trained artificial intelligence image recognition algorithm.

8. The method according to claim 1, wherein the voice assistance algorithm is a pre-trained artificial intelligence voice assistance algorithm.

9. The method according to claim 8, wherein the voice assistance algorithm is based on a large language model.

10. A non-transitory computer-readable storage medium comprising instructions that, when executed by one or more processors, cause the one or more processors to implement the method according to claim 1.

11. An electronic device for assisting a driver with driving a vehicle, said electronic device being suitable for connection to an electronic conversation module, the vehicle comprising at least one loudspeaker, a microphone and an image sensor, said electronic device comprising:
a creation module configured to create a user profile for the driver, the user profile comprising at least one user datum selected from the group comprising: the name of the driver, the occupation of the driver and a set of interest(s) of the driver,
a determination module configured to determine a physical state of the driver via at least one image received from the image sensor, said state being determined via the implementation of an image processing algorithm, and
a control module configured, when said determined state of the driver is among a predefined list of states, to control the electronic conversation module to implement a voice conversation with the driver via the at least one loudspeaker and the microphone, said electronic conversation module comprising a voice assistance algorithm,
wherein the control module is further configured to control the voice conversation based on the user profile and the physical state of the driver, which are received as input to the voice assistance algorithm.

12. The electronic device according to claim 11, wherein the creation module is further configured to create the user profile for the driver by asking the driver at least one question via the at least one loudspeaker, and by receiving via the microphone an answer for each of the at least one question.
